(19) United States
(12) Patent Application Publication
(10) Pub. No.: US 2010/0032522 A1
(43) Pub. Date: Feb. 11, 2010

(54) Centrally motor driven seaplane thrusters

(76) Inventors: Filiberto Palmiro Zadini, Northridge, CA (US); Giorgio Cesare Zadini, Camarillo, CA (US)

Correspondence Address: FILIBERTO P. ZADINI, 2237 HILLTOP LANE, CAMARILLO, CA, 93012, US

(21) Appl. No.: 12/380,081

(22) Filed: Feb. 23, 2009

Related U.S. Application Data
(60) Provisional application No. 61/188,344, filed on Aug. 8, 2008.

(51) Int. Cl. B64C 25/54; B64C 35/00

(52) U.S. Cl. 244/105

(57) ABSTRACT

A centrally motor driven thruster apparatus mounted in to a hull of a float of a seaplane including floatplanes and amphibious aircrafts. The thrusters, either water-jet thrusters or tunnel propeller thrusters are housed within the hull of the floats of a seaplane and provide the seaplane with slow speed maneuvering capabilities while the aircraft is in the water without the use of the on board screw propeller minimizing therefore the risks of damage to properties and/or humans. The thrusters are centrally motor driven sharing a common power unit. The thrusters, either water jet-thrusters or tunnel propellers thrusters, are driven by a common centrally located motor directly or indirectly actuated by the onboard Auxiliary Power Unit. The design and structure of the water-thrusters, either tunnel propellers thrusters or water-jet thrusters encompasses the use of lightweight material such as aluminum and/or fiberglass in order to minimize the addition of weight to the aircraft with the aim of not interfering with the plane aerodynamics during flight including takeoff and landing.

### RELATED MATTER

This application claims priority to U.S. Provisional Patent Application No. 61/188,344, filed on Aug. 8, 2008, and entitled Seaplane Float Thrusters, the relevant content of which is hereby incorporated by reference.

### FIELD OF INVENTION

This application relates to ways and means to facilitate slow speed maneuvering, docking, undocking, berthing, un-berthing, emergency steering and station keeping at zero or slow speed forward or reverse of seaplanes in water via water-jet thrusters or tunnel propeller thrusters, all thrusters being centrally driven directly or indirectly by the an on-board motor.

### BACKGROUND OF THE INVENTION

Docking, undocking, berthing, un-berthing and in general slow speed maneuverability of a seaplane in water is a well recognized problem by all seaplane pilots. There are intrinsic difficulties in maneuvering a seaplane via the on-board main engine especially in crowded waters and in strong wind conditions or both. Presently the only way to slow speed maneuvering a seaplane in water is to use concomitantly the rotating screw propeller actuated by the on-board main engine and the rudder which is usually mounted in the back of the floats of a seaplane. Highly specialized skills are necessary to achieve slow speed movements of a seaplane. Currently, the operation is largely dependent upon the skills of the pilot. However, despite the best efforts by pilots accidents still occur during the operation of slow speed maneuvering of a seaplane. These accidents are not only limited to inanimate structures but regretfully involve at times also humans. Indeed, the use of the screw propeller for seaplane maneuverability at slow speed is potentially a very risky and dangerous operation, as it can cause serious damages to properties including nearby seaplanes or boats in the area, to the seaplane itself and most important to humans.

The main reason why the screw propeller is inadequate to achieve maneuverability in crowded waters and worse in strong wind conditions is due to the fact that fine sideways movements are very hard to achieve with a front screw propeller and a rudder. A search in the Patent Office has revealed no prior art with regards to ways and means to maneuvering a seaplane at slow speed with the use of centrally motor driven thrusters. Specifically Applicants have found no references to the use of tunnel thrusters or water jet-thrusters centrally motor driven for instance by the auxiliary power unit in seaplanes.

A search in the Patent Office has revealed that Labouchere in his U.S. Pat. No. 5,913,493 entitled “Seaplane Hull”, issued Jun. 22, 1999 discloses propellers tunnel thruster units driven by in loco electrical motors mounted transversally in the bow of a seaplane float, much alike the water thrusters used in boats. Here below is the paragraph by Labouchere disclosing the in loco propellers motor driven thrusters:

“Although not illustrated, further features may include, for low speed water handling, a thruster unit driven by an electric motor and mounted transversely in the bow to steer the bow at low speed independently of forward speed to help berthing. Either a second thruster unit can be mounted in the stern or a water propeller can be mounted on the submerged lower section 15 of the air rudder 14. This propeller can be driven by an electric motor mounted in an extension of the rudder forward of the rudder hinge line, thus also serving as a control weight balance.” The propellers of Labouchere patent are driven by electrical motors in loco, housed within the bow and/or the stern. The bow and stem thrusters disclosed by Labouchere are not centrally driven by a commonly shared motor but are driven by an electrical motor or motors in loco, housed in each hull. In Labouchere cited patent the motor placed in the bow and the stem necessarily add significant weight to the float to the point that heavy interference with the aircraft aerodynamics of the seaplane when the seaplane is airborne is expected, including during takeoff and landing, affecting balance, speed and generally maneuverability of the seaplane in the air.

Furthermore Applicants have found no references to the use of water-jet thrusters in seaplanes for low speed maneuverability in the water. The water jet-thrusters can be either mounted into the seaplane float hulls just below the waterline at time of assembly or retrofitted, mounted at a later date.

### BRIEF SUMMARY OF THE INVENTION

With the present Patent Application, Applicants disclose centrally motor driven tunnel propeller or water-jet thrusters mounted in the hull of a float of a seaplane or amphibious aircraft to enhance aircraft slow speed maneuverability in water without the use of the on board screw propeller.

In marine technology, tunnel thrusters are propulsion devices, powered by in loco motors, built into or mounted into the bow or stem of ships or boats to enhance maneuverability. Bow and stem tunnel thrusters make docking of the boat or ship easier since allow the operator of the boat or ship to turn the vessel to port-left side- or starboard-right side- or simply allow the vessel operator to move at slow speed the vessel in both directions, parallel or at a steady angle in respect to the dock line or the coastline without the use of the main screw propeller which requires forward motion for turning.

The addition of centrally motor driven thrusters, either tunnel propeller thrusters or water jet-thrusters, to the hulls of the floats of a seaplane or an amphibious aircraft is a novel and an extremely useful feature.

In contrast to Labouchere cited Patent in which each thruster propeller is driven by an individual in loco motor, all propellers thrusters disclosed in the present application are driven by a commonly shared motor unit, directly or indirectly fed electrically by, for instance, the auxiliary power unit generator, already present in the plane and operating in the plane for other functions such as providing electricity, hydraulic pressure, air conditioning and also for starting the onboard propeller engine.

The use of the already present on board auxiliary power unit for actuating the rotation of all propellers thrusters in the case of tunnel thrusters adds significant less weight to the seaplane in respect to Labouchere in loco motors. In the present Application, only the weight of a propeller and the geared rods for connection from the centrally located motor to the propeller are mounted in to the individual float where weight is a critical factor with regard to stability and maneuverability of the aircraft in the air. In the present patent application propellers and gears are made of lightweight material such as aluminum and/or plastic/fiberglass material to reduce the added weight to a minimum.

Centrally motor driven water-jet thrusters also provide seaplane lateral/forward or reverse displacement capabilities in the water without the addition of individual water-jet thrusters motor units in each hull, unavoidably heavier than a single jet thrusters centrally motor driven unit connected to the thrusters nozzles mounted in each hull.

The nozzles of the centrally motor driven water jet-thrusters disclosed by Applicants are indeed in flow communication with a pumping device or waterjet generating device for water discharge under high pressure for propulsion purposes via the use hollow pipes made of lightweight material such as aluminum or fiberglass/plastic. A central directional valve control unit actuates the specific water-jet thrusters nozzle needed for a specific seaplane displacement in the water.

The water thrusters, tunnel propeller or water-jet thrusters allow maneuverability in the water at slow speed of the seaplane or amphibious aircraft without the use of the onboard rotating propeller. With the use of Applicants disclosed thrusters mounted to the hull of the floats of a seaplane or amphibious aircraft, the operation of docking/undocking/berthing/un-berthing and in general slow speed maneuverability of a seaplane or amphibious aircraft in water is not only an easier procedure but a much safer one, as the main screw propeller is motionless, not rotating as it is not used for the slow seaplane movements in water.

### OBJECTS OF THE INVENTION

It is an object of the present invention to provide seaplanes of all type, i.e. float planes and amphibious aircrafts with slow speed maneuvering capabilities to facilitate docking, undocking, berthing/un-berthing, emergency steering and station keeping at slow speed, forward or reverse

It is an object of the present invention to provide a seaplane with ways and means to turn, to move laterally at a steady angle in respect to the dock or coastline, without the use of the main on-board engine minimizing therefore the possibility of damage to properties and or humans.

It is an object of the present invention to make the operation of docking/undocking, berthing/un-berthing of a seaplane and in general the operation of slow speed maneuverability of a seaplane or amphibious aircraft an easier and safer procedure as the screw propeller is at still.

It is an object of the present invention to provide a seaplane with a lightweight efficient directional system via the use of propellers or nozzles both placed in the hull of the floats of a seaplane or amphibious aircraft, simple in structure and design, to allow slow speed maneuverability in the water.

It is an object of the present invention to provide a seaplane with a lightweight efficient directional system while the seaplane is in water, simple in structure and design in order not to interfere with seaplane aereodynamics when the seaplane is airborne.

It is an object of the present invention to provide a seaplane with a lightweight efficient directional displacement system while the seaplane is in the water via the use of propellers or nozzles, both placed in the hull of the floats of a seaplane or amphibious aircraft and all actuated by a single motor to save considerable weight in respect to seaplanes with “one motor for one thruster” structure and design.

### FIGURES

FIG. 1 is a side view of a seaplane with a see thru view of the water-jet thruster housed in the hull of the left float.

FIG. 1A is a cross sectional enlarged view from above of a detail of FIG. 1, precisely of the left hull of the float with the water-jet nozzles apparatus housed within the hull.

FIG. 1B is a side view from below of the seaplane hull of FIG. 1.

FIG. 1C is an open view from above of the water-jet generating device and the central valve control unit centrally located within the fuselage.

FIG. 1D is an enlarged side view of the central valve control unit open to view, without the case box.

FIG. 1E is an enlarged cross section view of the central valve control unit of FIG. 1D.

FIG. 2 is a side view of another embodiment of the jet-thruster of FIG. 1, a compressed air-jet thruster.

FIG. 3 is a cross sectional view from above of the left hull of the float of the seaplane with the propeller apparatus housed within the hull and connected to the central motor via a gear apparatus.

FIG. 3A is view from above of the motor and the propellers gear shifting control unit centrally located within the fuselage and a cross sectional view from above of the left hull of the float of the seaplane of FIG. 3.

### SPECIFICATIONS

A preferred embodiment of this invention consists of a centrally motor driven water-jet thrusters apparatus generally indicated at 1 mounted in seaplane 2. The meaning to be given to the designation of a central common motor unit is substantially that the central motor unit actuates at least two thrusters, each of one capable of displacing the seaplane in water in a direction different from the other thruster. Although the preferred location for a centrally located common motor unit is within or by the fuselage for seaplane aerodynamic stability and maneuverability during flight, a centrally located common motor unit may also by be located outside the fuselage in the neighborhood of the centroid of the floating apparatus of the seaplane, i.e. around the midline of a float, should the seaplane carry a single wide float, or between symmetrically located floats should the plane carry a pair or pairs of floats. The structure and design of a seaplane thruster apparatus in which all thrusters share one or two motor—one being likely sufficient—saves considerably weight to the seaplane in respect to a seaplane having “one motor for one thruster” structure and design.

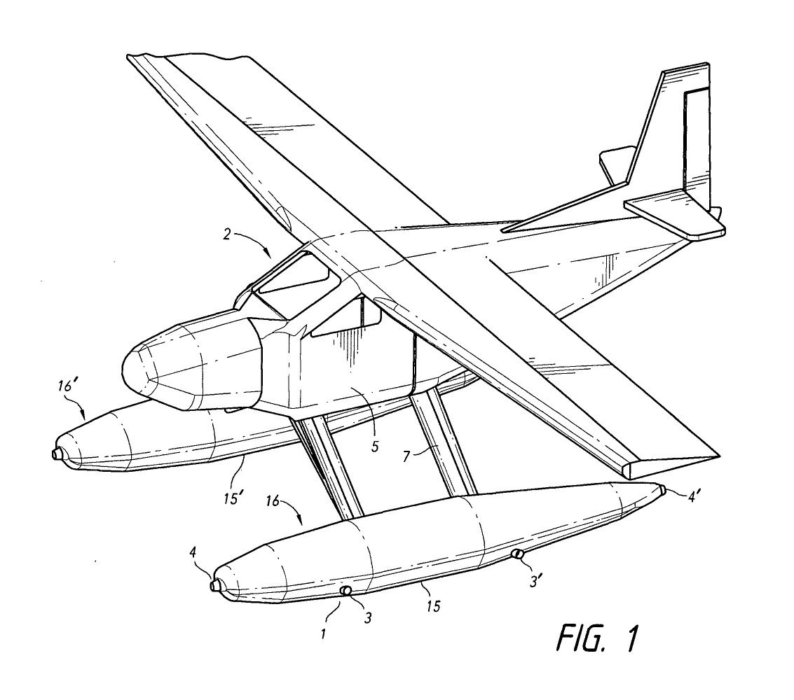

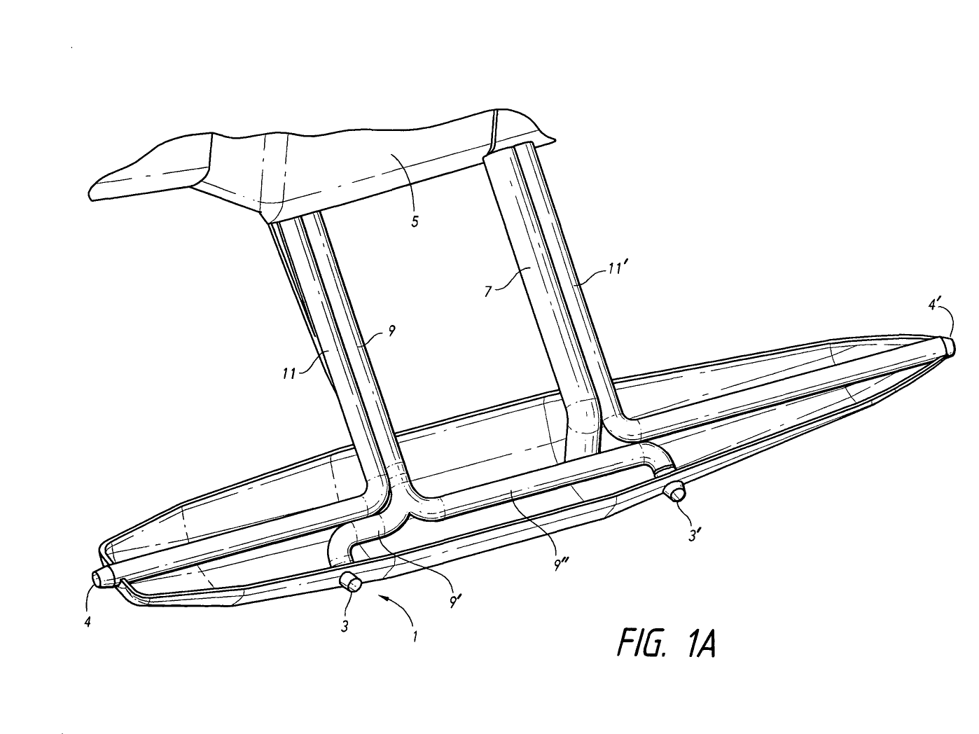

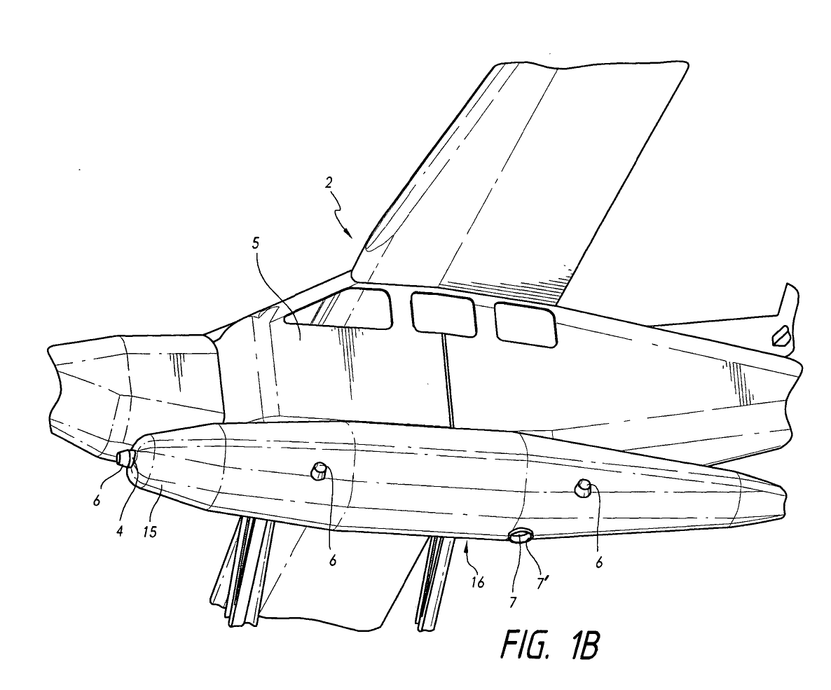

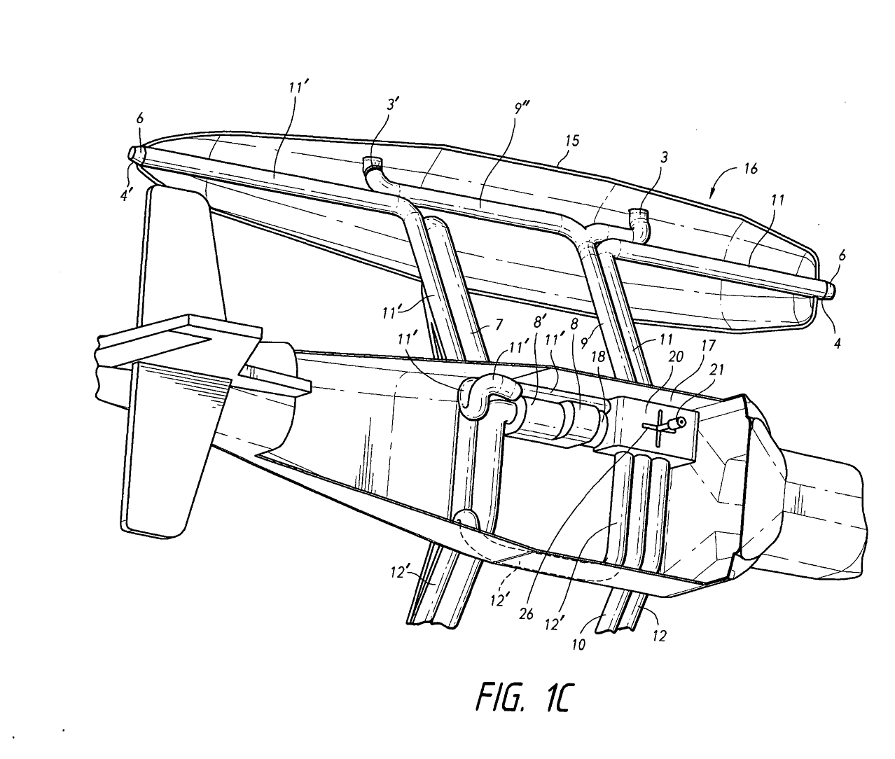

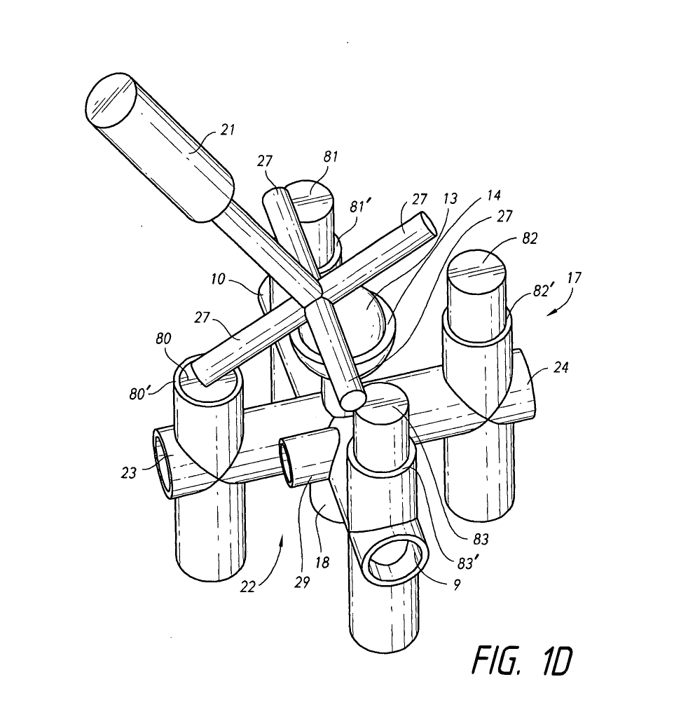

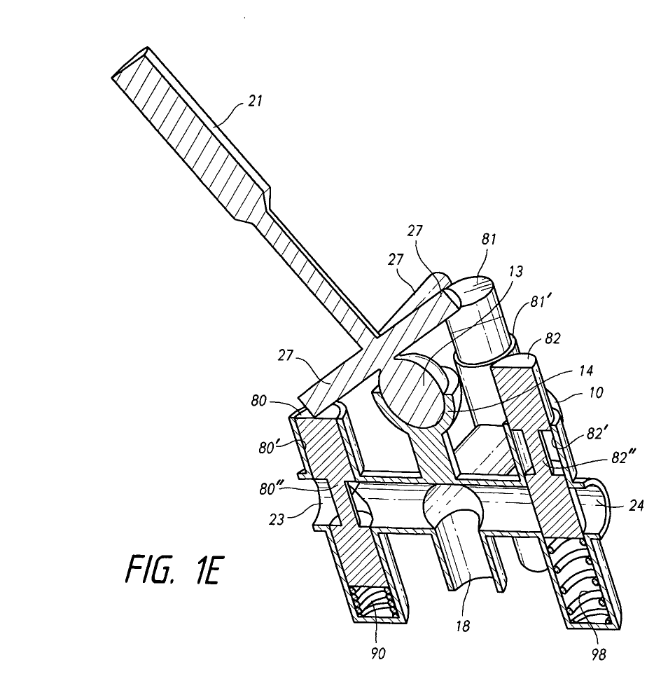

As shown in FIG. 1, water jet thrusters apparatus 1 comprises bow side water jet thruster 3, stern side water jet thruster 3′, front water jet thruster 4 and rear water jet thruster 4′, all connected as shown in FIG. 1C via hollow pipes 9′, 9″, 9, 11, 11′, 10, 12, 12′ and as below described, to water-jet thrusters pumping device means or water jet generating device means for high pressure water discharge 8, centrally located within fuselage 5 or by its exterior.

As shown in FIG. 1C, water-jet thrusters pumping device means or water jet generating device means for water discharge under high pressure for propulsion 8 is actuated by motor 8′ electrically powered by the on board electrical current generated by the auxiliary power unit not shown.

As better shown in FIG. 1A water jet thrusters apparatus 1 includes aspiration hollow pipe 7, discharge common hollow pipe 9 which branches out into hollow pipe 9′ for bow side thrusters 3 and hollow pipe 9″ for stern side thruster 3′, discharge hollow pipes 11 for front thruster 4 and 11′ for rear thruster 4′. Applicants propose the use of water-jet thrusters as a preferred embodiment of their invention mainly because of design simplicity and because of the absence of moving parts except for pumping device means or water jet generating device means 8 centrally located within fuselage 5 or at its exterior.

As shown in FIG. 1A, high pressure nozzles 6 of water jet-thruster or water jet-thruster means or thruster means 3, 3′,4, 4′ are formed or mounted at the distal end of hollow pipes 9′, 9″, 11, 11′. Nozzles 6 are housed in hull 15 of float 16 of seaplane 2, just below the water line. High pressure nozzles 6 are designed to increase the velocity of the exiting water jet. Both hulls 15 and 15′ respectively of float 16 and 16′ carry the same apparatus. For the purpose of description, as shown in FIG. 1C, to pipe 11 of float 16 corresponds pipe 12 of float 16′, to pipe 11 ′ of float 16 corresponds pipe 12′ of float 16′, and to pipe 9 of float 16 corresponds pipe 10 of float 16′.

As shown in FIG. 1B, water aspiration pipe 7 has intake 7′ in the inferior aspect of hull 15, where water gets suctioned and aspirated into water-jet generating unit or pumping device 8. As shown in FIG. 1C, discharge of water under pressure is controlled by valve control unit 17 operated by the pilot in the cockpit. Valve control unit 17 includes lever 21 and valve box 20, which encloses block 22. Block 22 is shown in FIGS. 1D and 1E. Block 22 comprises hollow pipe 23, hollow pipe 24, hollow pipe 9 and hollow pipe 10. Hollow pipe 23 is a pipe resulting from the convergence of pipe 11 which is in flow communication with front water jet thruster 4 of float 16 and the corresponding pipe of the other float, also in flow communication with the front thruster of the other float. Hollow pipe 24 is a pipe resulting from the convergence of pipe 11 ′ which is in flow communication with rear water jet thruster 4′ of float 16 and the corresponding pipe of the other float, also in flow communication with the rear thruster of the other float. Hollow pipe 9 is a pipe in flow communication with side thrusters 3 and 3′ of float 16, and hollow pipe 10 is a pipe correspondent to pipe 9 in flow communication with the side thrusters of the other float. Pipe 23 is in straight line continuity with pipe 24 and pipe 9 is in straight line continuity with pipe 10. Pipe 23, 24, 9 and 10 are arranged together to form the four arms of a cross and are all in flow communication at the junction of the arms. At the junction of the arms, another pipe, pipe 18, joins and is in flow communication with pipes 23, 24, 9 and 10. Pipe 18 is the pipe coming directly from pump 8 which receives water from intake pipe 7. Along pipes 23, 24, 9 and 10, at the same distance from the junction point of such four pipes valves are located to selectively allow water flow from pipe 18 to selected water jet thrusters while at the same time preventing water flow through other jet thrusters.

As shown in FIG. 1D and as further shown in FIG. 1E, which is a cross sectional view of unit 17 represented in FIG. 1D, unit 17 is shown without enclosing valve box 20 to allow visualization of valves and pipes. Piston shaped valves 80, 81, 82, as well as valve 83 which is not shown in FIG. 1E, are slideably mounted, respectively, in cylindrical sleeves 80′, 81′, 82′ and 83′ which are water tightly mounted respectively on pipe 23, 24, 9 and 10 and oriented at right angle in respect to the pipes they are mounted on. Valves are shaped as pistons having a middle segment of reduced diameter, such as segment 80″ for valve 80 and segment 82″ for valve 82, as shown in FIG. 1E. In resting position valve 80, 81, 82 and 83 are pushed upward by a spring such as spring 98 for valve 82. When in resting upward position, valves 80, 81, 82 and 83 shut off water flow along discharge pipes 23, 24, 9 and 10 inactivating water jet thrusters, while when in downward position as valve 80 is shown in FIG. 1E, valves open water flow along the discharge pipe activating water jet thrusters. Lever 21 pivots on a ball and socket type of joint via its spherical arm 13 engaged into socket 14 anchored to block 22, but its movements are restricted by lever guiding slots 26 formed on top side of valve box 20 and arranged in a shape of a cross to fittingly superimpose on cross formed by pipes 23, 24, 9 and 10. Due to the presence of slot 26, the only allowed movements for lever 21 are forward-backward, or backward-forward, and left-right, or right-left.

As shown in FIG. 1D, lever 21, just above its spherical pivoting arm 13, has four arms 27 outwardly protruding at right angle from the lever longitudinal axis and at right angle from one another, so as to be arranged in the shape of a cross to fit into cross shaped slots 26 of top side of valve box 20. When lever 21 is tilted toward one of 80, 81, 82, 83 valves, one of its arm 27 engages the valve which the lever is tilted toward and depresses such valve against the action of its spring 90, as shown for valve 80 in FIG. 1E. Therefore, by actuation of lever 21, i.e. by the action of tilting of lever 21, in any of the allowed directions, the pilot can open selectively the valve that activates the desired water jet and enable the seaplane to move into the desired direction. Conduit 29, shown in FIG. 1D, in flow communication with pipes 18, 23, 24, 9, and 10, is a conduit for the priming of pump 8. When pump 8 is turned on, and lever 21 is in its resting upward position, water is suctioned and aspirated through pipe 7 into pump 8 and ejected into pipe 18 then into conduit 29 which discharge water out of the plane to allow priming of pump 8. A shut off valve, not shown, which can be shut off by electrical or manual switch shuts off the water flow through conduit 29 when priming of pump 8 is achieved. Shut off of priming conduit can also be achieved automatically via a mechanical or electrical activation as a result of any movement applied upon lever 21.

In use the pilot will activate pump 8′ and with lever 21 will act upon each specific valve in order to achieve a specific movement of the seaplane. In detail, water-jet thruster is operated as follows: water is aspirated through aspiration intake/inlet 7 via intake 7′ into pumping device 8. Depending upon the maneuver that the pilot wants to carry out, water is discharged under high pressure through pipe 9 into pipes 9′ and 9″ for water-jet thrusters 3 and 3′ and through pipes 11 and 11′ for water-thrusters 4 and 4′. Water is expelled through high pressure discharge nozzle 6. Side movements of seaplane 2 will be actuated by side thrusters 3 and 3′. Forward movement of seaplane 2 is actuated by water-thruster 4′ while reverse movement is actuated by water thruster 4. Directional valves unit 17 allows the control of water jet expulsion through each nozzle as shown in FIG. 1B for lateral motion, for forward motion and back motion.

Slow speed lateral or side displacement of seaplane 2, parallel or at a steady angle towards the dock or coastline can be accomplished by the activation of bow side discharge thruster 3 and stem side thruster 3′ in the right or left float depending upon the position of seaplane 2 in respect to the dock or coastline. Same operation is carried out to move away from the dock or coastline with the activation of bow and stem thruster in the opposite float.

By actuating the water jet thrusters of each float independently, for instance by connecting the thrusters of each float separately to an independent control unit, mobility of the seaplane may be made even more versatile and extremely accurate in very limited space. For instance, turning could be achieved around a vertical axis passing through the center of the plane by reverse movement of one float and forward movement of the other.

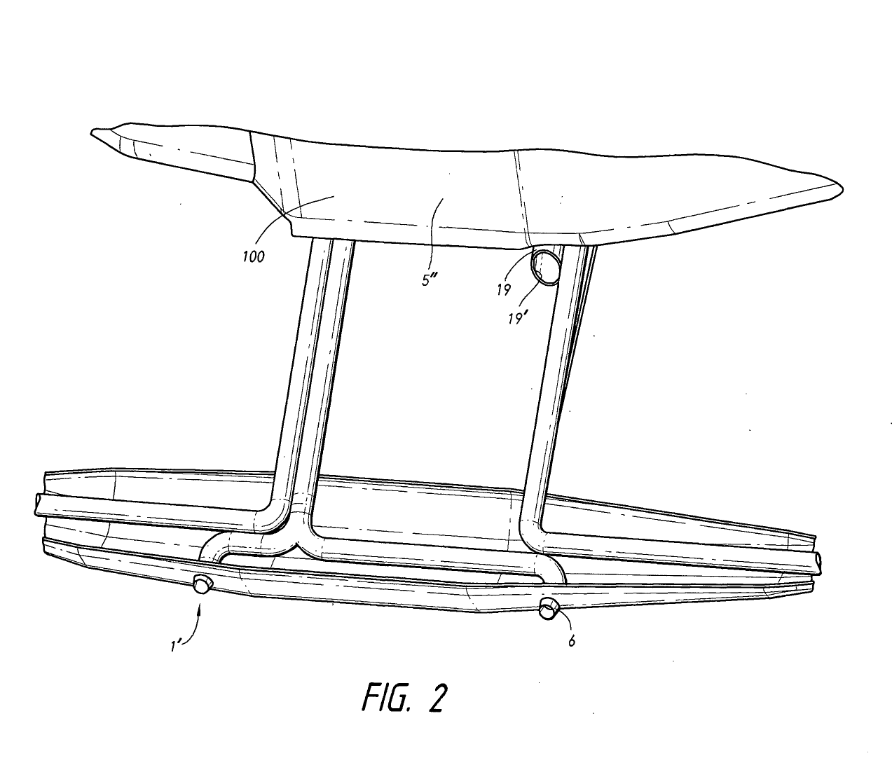

Another type of embodiment is illustrated in FIG. 2. In this embodiment jet thrusters apparatus generally indicated at 1′ is exactly the same as apparatus 1 of FIG. 1A, 1B, 1C, the difference being that in jet apparatus 1′ not water but compressed air is expelled thru nozzles 6 underwater for achieving movements of seaplane 100.

Indeed aspiration pipe 7 does not aspirate water but air, being pipe 19 much shorter, with intake 19′ not being submerged in water as for intake 7 of pipe 7′ but being located in proximity of the surface of the wall of fuselage 5″. The rest of the of apparatus 1′ is the same as apparatus 1 in design, structure and operation.

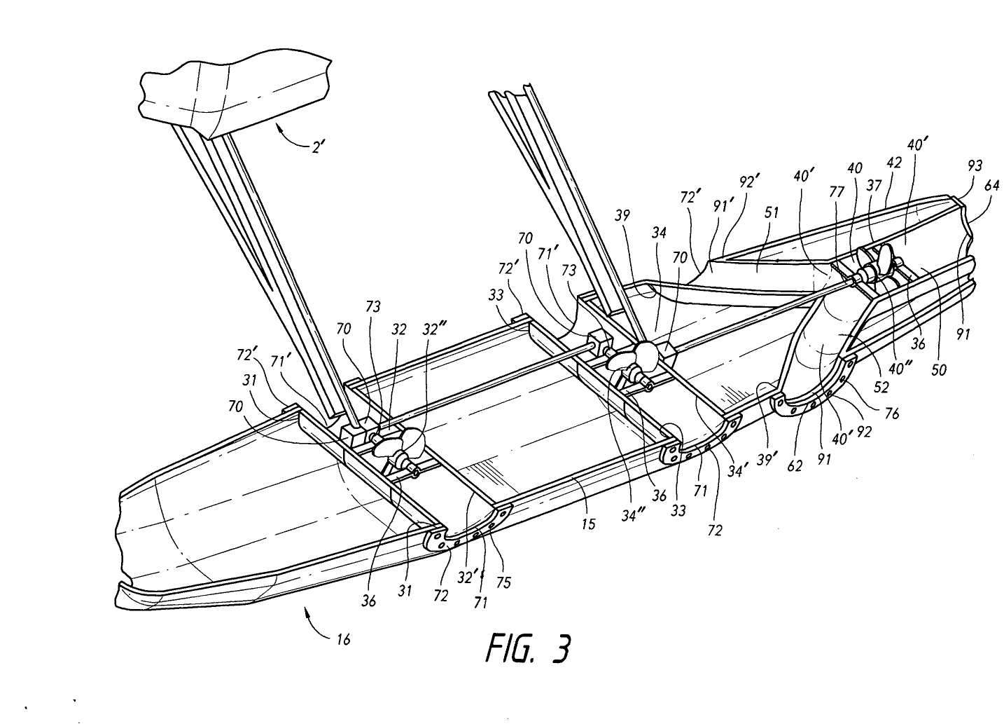

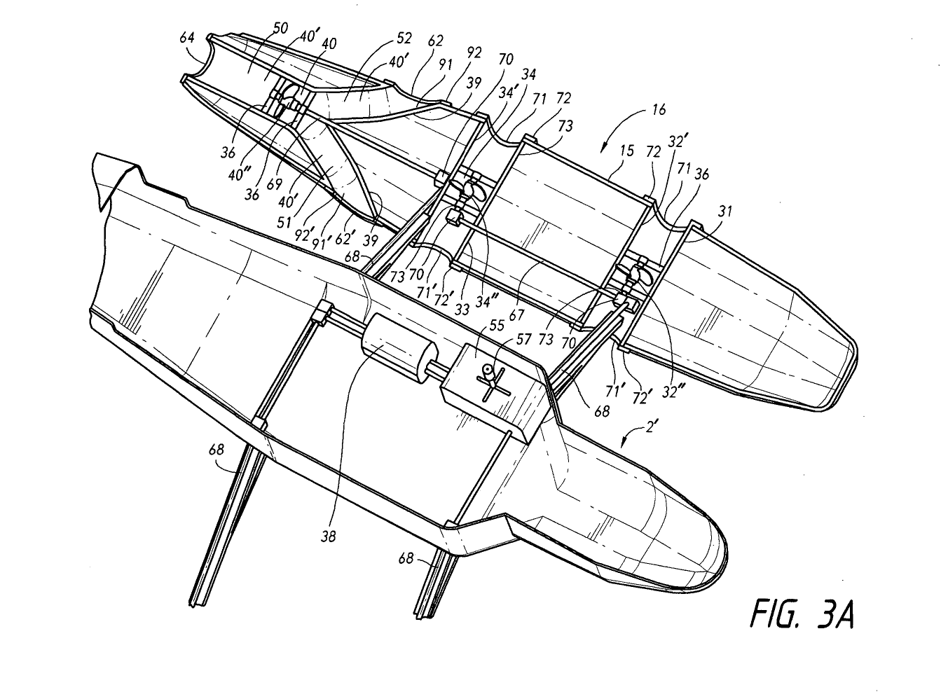

In FIG. 3 another type of thrusters of seaplane 2′ is illustrated, precisely propeller tunnel thruster units 32, 34 and 40. Propeller tunnel thruster units 32 and 34 are side propeller tunnel thrusters located at the side of hull 15 of float 16, tunnel thruster 32 being closer to the bow and tunnel thruster 34 being closer to the stern, while tunnel thruster unit 40 is a rear propeller thruster, locate at stem 42 of hull 15 of float 16. Side tunnel thruster units 32 and 34 include, respectively, tunnel sleeves 32′ with screw propeller or propelling means 32″ and tunnel sleeve 34′ with screw propeller or propelling means 34″. Tunnel sleeves 32′ and 34′ are respectively mounted in tunnel 31 and 33 which are formed within hull 15 of float 16, transversally perforating hull 15 of float 16 all the way across in order to allow unobstructed flow of water within the tunnel sleeves when screw propellers 32″ and 34″ are rotating, either clockwise or anticlockwise. Tunnel sleeves 32′ and 34′ have flanges 72 and 72′ at each end 71 and 71′ of tunnel sleeves 32′ and 34′ to secure tunnel sleeves 32′ and 34′ to hull 15 of float 16 via screws or fastening means 75. Screw propellers 32″ and 34″ are respectively mounted in tunnel sleeves 32′ and 34′ via supporting arms 36 with their axis 73 oriented parallel to the longitudinal axis of tunnel sleeves 32′ and 34′. Side propellers or propelling means 32″ and 34″ of tunnel thruster units or means 32 and 34 provide seaplane 2′ with lateral and turning displacement/motion capabilities.

Rear tunnel thruster 40 includes tunnel sleeve 40′ with screw propeller or propelling means 40″. Tunnel sleeve 40′ is Y shaped, with a single rear segment 50 branching forwardly into two side segments 51 and 52, directly sideways and forwardly. Tunnel sleeve 40′ is fittingly mounted on a Y shaped tunnel formed in the stern of hull 15 of float 16. Tunnel sleeve 40′ is Y shaped in order to allow unobstructed flow of water from lateral opening 62 of side segment 52 and opening 62′ of side segment 51 to rear opening 64 of rear segment 50 and vice versa when screw propeller or propelling means 40″ rotates either clockwise or anticlockwise.

Tunnel sleeve 40′ has flange 92 at end 91 of side segment 52 of tunnel sleeve 40′, flange 92′ at end 91′ of side segment 51 of tunnel sleeve 40′ and flange 93 at end 93 of rear segment 50 of tunnel sleeve 40′ to secure tunnel sleeve 40′ to hull 15 of float 16 via screws or fastening means 76. In Y shaped rear tunnel sleeve 40′, screw propeller or means 40″ is mounted in the same fashion tunnel thrusters propellers 32″ and 34″ are mounted in tunnel thruster sleeve 32′ and 34′, via support arms 36. Axis 77 of screw propeller or means 40′ is oriented parallel to the longitudinal axis of rear segment 50 of rear tunnel sleeve 40′. Rear tunnel thruster 40, mounted at the stern 42 of hull 15 of float 16, provides forward and reverse motion to the seaplane, depending upon the direction of turning of the propeller or propelling means 40″, anticlockwise for forward motion or clockwise for reverse motion.

As shown in FIG. 3A, propellers 32″, 34″ and 40″ respectively of tunnel thruster units 32, 34 and 40 are driven by centrally located electrical motor 33, controlled from the cockpit and connected to propellers 32″, 34″ and 40″ via transmission means 66 inclusive of rods 68 and gear boxes 70. Tunnel thrusters 32, 34 and 40 do not house any motor in loco. As for the water-jet thrusters above described the meaning to be given to the designation of a central common motor unit or a centrally located motor unit is substantially that the central motor unit actuates at least two thrusters, each of one capable of displacing the seaplane in water in a direction different from the other thruster. Although the preferred location for a centrally located common motor unit is within or by the fuselage for seaplane aerodynamic stability and maneuverability during flight, a centrally located common motor unit may also by be located outside the fuselage in the neighborhood of the centroid of the floating apparatus of the seaplane, i.e. around the midline of a float, should the seaplane carry a single wide float, or between symmetrically located floats should the plane carry a pair or pairs of floats. The structure and design of a seaplane thruster apparatus in which all thrusters share one or two motor—one being likely sufficient—saves considerably weight to the seaplane in respect to a seaplane having “one motor for one thruster” structure and design. As above described, tunnel thruster units 32, 34 and 40 are only provided, respectively, with rotating propellers 32″, 34″, 40″ which are driven by centrally located motor 33 via gear means 66. Gear shifting control unit 17′ includes gear shifting box 31 and gear shifting lever 37. The mechanics of gear shifting control unit is not shown because it is similar to typical gear shifting units already in existence.

Gear shifting control unit 17′ allows the pilot to shift to any propeller at the needed speed of rotation by acting upon lever 37.

Lateral displacement of seaplane 2′ in the water parallel to or at a steady angle in respect to the dock or coastline is achieved by the simultaneous use of side bow thruster 32 and side stem thruster 34 and/or the use of the corresponding side bow and side stem thruster in the opposite float in either direction, toward the dock and coastline and away from the dock and coastline. Clockwise turning of seaplane 2′ can accomplished by forward propulsion of propeller 34″ and reverse propulsion of propeller 32″. Anticlockwise turning of seaplane 2′ is achieved by reverse propulsion of propeller 34″ and forward propulsion of propeller 32″. The above described movements in the water can also be accomplished by the addition and use of a rudder. Forward and backward motion of seaplane in a straight line is accomplished by back tunnel thruster propeller 40′ in forward or reverse motion.

By actuating the tunnel thrusters of each float independently, for instance by connecting the thrusters of each float separately to an independent control unit, mobility of the seaplane may be made even more versatile and extremely accurate in very limited space. For instance, turning could be achieved around a vertical axis passing through the center of the plane by reverse movement of one float and forward movement of the other.

What we claim is:

1. A seaplane having a fuselage and a floating apparatus including one or more floats, comprising:
thruster means mounted in the floating apparatus, to enable movements of the seaplane on water upon actuation of said thruster means,
at least one motor unit, said motor unit being essentially centrally located by the fuselage in respect to said floating apparatus and being connected to said thruster means via connecting means to actuate said thruster means upon actuation of said motor unit.

2. The device of claim 1 wherein said thruster means are water-jet thrusters comprising nozzles, wherein water is aspirated through an underwater intake opening and discharged under pressure through the nozzles,
said water-jet thrusters being in flow connection with a centrally located valve control unit via hollow pipes carrying water, said valve control unit being in flow communication with a high pressure water-jet generating unit actuated by a motor actuated by an electrical current.

3. The device of claim 1 wherein said thrusters are compressed air thrusters wherein air is aspirated through an air intake opening above the water line and discharged under pressure underwater through nozzles,
said thrusters being in flow communication with a centrally located valve control unit via hollow pipes carrying compressed air, said valve control unit being in flow communication with a high pressure air-jet generating unit actuated by a motor actuated by an electrical current.

4. The device of claim 1 wherein said thrusters are propeller tunnel thrusters wherein the propeller is driven by the centrally located motor unit via transmission gear means.

5. A seaplane having a fuselage and a floating apparatus including one or more floats, comprising:
thruster means mounted in the floating apparatus, to enable movements of the seaplane on water upon actuation of said thruster means, and
a common motor shared by at least two thrusters for propulsion purposes.

6. The seaplane of claim 5, wherein said thrusters sharing said common motor are capable of causing displacement in different directions.
